(19) United States
(12) Patent Application Publication
(10) Pub. No.: US 2006/0083574 A1
(43) Pub. Date: Apr. 20, 2006

(54) Tube assembly for hot melt glue gun

(76) Inventor: Grace Lee, Chia Yi Hsien (TW)

Correspondence Address: STITES & HARBISON PLLC, 1199 NORTH FAIRFAX STREET, SUITE 900, ALEXANDRIA, VA, 22314, US

(21) Appl. No.: 10/961,195

(22) Filed: Oct. 12, 2004

(51) Int. Cl. B43M 1/02; A47L 13/32; A46B 11/08

(52) U.S. Cl. 401/2

(57) ABSTRACT

A hot melt glue gun includes a barrel, an inner tube, and an outer tube. A glue stick is guided through the barrel. The inner tube includes an end mounted around an open end of the barrel. The inner tube is made of tackfree silicon rubber and includes an inner periphery that is in contact with a circumference of the glue stick passing therethrough. The outer tube is made of Teflon and securely mounted around the inner tube and the open end of the barrel. The outer tube includes an inner diameter greater than that of the inner tube such that the circumference of the glue stick is not in contact with an inner periphery of the outer tube, preventing the glue stick from being adhered to the inner periphery of the outer tube.

### BACKGROUND OF THE INVENTION

1. Field of the Invention

The present invention relates to a tube assembly for a hot melt glue gun. In particular, the present invention relates to a tube assembly for a hot melt glue gun for guiding the glue stick and for preventing the glue stick from being adhered to an inner periphery of an outer tube of the tube assembly.

2. Description of the Related Art

FIG. 2 of the drawings illustrates a hot melt glue gun with a conventional tube assembly. The hot melt glue gun comprises a metal barrel 1′ including an open end 11′. A heat-resistant, tackfree sleeve 2′ is made of silicon rubber and has an end mounted around the open end 11′. A metal wire 3′ is wound around the end of the sleeve 2′ for securing the sleeve 2′ to the barrel 1′. The sleeve 2′ receives and guides a glue stick 4′ that is heated by a heating member 5′ below the barrel 1′. Molten glue is outputted via an outlet 12′ of the barrel 1′. However, since the sleeve 2′ is tied up with the metal wire 3′, the sleeve 2′ made of silicon rubber deteriorates and breaks after a period of time. Thus, molten glue flows to the heating member 5′ via the cracks H, resulting in short circuit and explosion of the heating member 5′.

A heat-resistant, rigid outer tube 6′ made of Teflon has been proposed to solve this problem, as illustrated in FIG. 3. The outer tube 6′ is mounted around the sleeve 2′ and the open end 11′ of the barrel 1′, and a metal wire 3′ is used to secure the outer tube 6′. A glue stick 4′ is guided by the sleeve 2′ and melted by the heating member 5′ below the barrel 1′. The molten glue exits the barrel 1′ via an outlet 12′ of the barrel 1′. Since the sleeve 2′ has an inner diameter the same as that of the outer tube 6′, the glue stick 4′ is in contact with an inner periphery of the sleeve 2′ and the inner periphery of the outer tube 6′. However, the molten glue may be adhered to the inner periphery of the outer tube 6′ made of Teflon that is not tackfree.

### SUMMARY OF THE INVENTION

In accordance with an aspect of the present invention, a hot melt glue gun comprises a barrel including an open end, an inner tube, and an outer tube. A glue stick is guided through the barrel. The inner tube includes an end mounted around the open end of the barrel. The inner tube is made of tackfree silicon rubber and includes an inner periphery that is in contact with a circumference of the glue stick passing therethrough. The outer tube is made of Teflon and securely mounted around the inner tube and the open end of the barrel. The outer tube includes an inner diameter greater than that of the inner tube such that the circumference of the glue stick is not in contact with an inner periphery of the outer tube, preventing the glue stick from being adhered to the inner periphery of the outer tube.

Other objectives, advantages, and novel features of the invention will become more apparent from the following detailed description when taken in conjunction with the accompanying drawings.

### BRIEF DESCRIPTION OF THE DRAWINGS

FIG. 1 is a sectional view of a hot melt glue gun with a tube assembly in accordance with the present invention.

FIG. 2 is a sectional view of a hot melt glue gun with a conventional tube assembly.

FIG. 3 is a sectional view of a hot melt glue gun with another conventional tube assembly.

### DETAILED DESCRIPTION OF THE PREFERRED EMBODIMENT

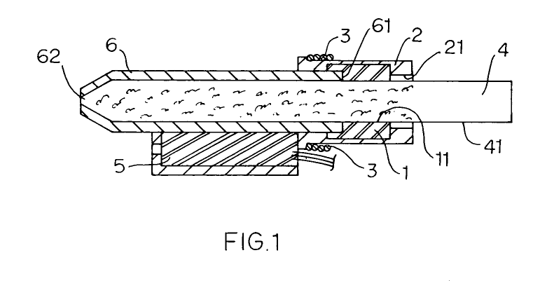

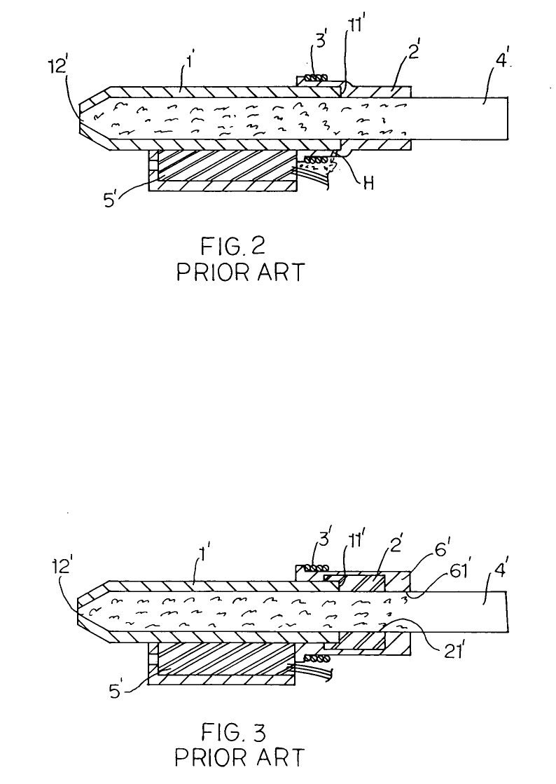

Referring to FIG. 1, a hot melt glue gun in accordance with the present invention comprises a barrel 6, a heating member 5 mounted below the barrel 6, and a tube assembly including an inner tube 1 and an outer tube 2.

The inner tube 1 is a hollow tubular member made of heat-resistant, tackfree silicon rubber and includes two open ends. The inner tube 1 has an end mounted around an open end 61 of the barrel 6. Further, the inner tube 1 has an inner diameter the same as an outer diameter of a glue stick 4 such that a circumference of the glue stick 4 is in contact with an inner periphery 11 of the inner tube 1.

The outer tube 2 is mounted around the inner tube 2 and the open end 61 of the barrel 6. The outer tube 2 is made of heat-resistant, rigid Teflon. The outer tube 2 has an inner diameter greater than that of the inner tube 1 such that the glue stick 2 will not be in contact with an inner periphery 21 of the outer tube 2 when the glue stick 4 is passing through the outer tube 2. Thus, the glue stick 4 is only in contact with the inner periphery 11 of the inner tube 1 without contact with the inner periphery 21 of the outer tube 2, preventing the glue stick 4 from being adhered to the outer tube 2.

A metal wire 3 is wound around the outer tube 2, thereby securing the outer tube 2 to the open end 61 of the barrel 6 made of metal.

The glue stick 4 is guided through the barrel 6 and melted by the heating member 5 below the barrel 6. The molten glue exits the barrel 6 via an outlet 62 of the barrel 6.

Since the outer tube 2 is made of Teflon that is heat-resistant and rigid, it would not break during use. Thus, the outer tube 2 is fixedly mounted by the metal wire 3 to the open end 61 of the barrel 6 without the risk of breakage while preventing the glue stick 4 from being adhered to the inner periphery 11 of the inner tube 1 made of tackfree silicon rubber and preventing the glue stick 4 from being adhered to the inner periphery 21 of the outer tube 2 made of Teflon that is not tackfree.

Although specific embodiments have been illustrated and described, numerous modifications and variations are still possible without departing from the essence of the invention. The scope of the invention is limited by the accompanying claims.

What is claimed is:

1. A hot melt glue gun comprising:
a barrel including an open end, a glue stick being guided through the barrel;
an inner tube including an end mounted around the open end of the barrel, the inner tube being made of tackfree silicon rubber and including an inner periphery that is in contact with a circumference of the glue stick passing therethrough; and
an outer tube made of Teflon and securely mounted around the inner tube and the open end of the barrel, the outer tube including an inner diameter greater than that of the inner tube such that the circumference of the glue stick is not in contact with an inner periphery of the outer tube, preventing the glue stick from being adhered to the inner periphery of the outer tube.
